(19) United States
(12) Patent Application Publication
(10) Pub. No.: US 2014/0335244 A1
(43) Pub. Date: Nov. 13, 2014

(54) FROZEN INSTANT TAPIOCA PEARLS AND METHOD FOR MANUFACTURING THE SAME

(71) Applicant: Fong Chen Frozen Food Co., Ltd., Pingtung County (TW)

(72) Inventors: Shih-Ting Chen, Pingtung County (TW); Chin-Hua Chiang, Pingtung County (TW)

(73) Assignee: Fong Chen Frozen Food Co., Ltd., Pingtung County (TW)

(21) Appl. No.: 14/105,244

(22) Filed: Dec. 13, 2013

(30) Foreign Application Priority Data
May 9, 2013 (TW) 102116509

(51) Int. Cl. A23L 1/187

(52) U.S. Cl. CPC A23L 1/187
USPC 426/250; 426/509; 426/560

(57) ABSTRACT

A method for manufacturing frozen instant tapioca pearls includes: (a) preparing raw tapioca pearls; (b) cooking the raw tapioca pearls to obtain cooked tapioca pearls; (c) soaking the cooked tapioca pearls in a hot water solution; (d) after step (c), cooling the cooked tapioca pearls using ice water; and (e) blowing cold air with a temperature of −5° C. to −40° C. over the cooked tapioca pearls at a wind speed ranging from 3 m/sec to 5 m/sec and a wind pressure ranging from 500 Pa to 1000 Pa so as to separate and quickly freeze the cooked tapioca pearls.

### CROSS-REFERENCE TO RELATED APPLICATION

This application claims priority of Taiwanese Application No. 102116509, filed on May 9, 2013.

### BACKGROUND OF THE INVENTION

1. Field of the Invention

This invention relates to a method for manufacturing tapioca pearls and a frozen instant tapioca pearl made therefrom, more particularly to a method for mass production and efficient manufacture of frozen instant tapioca pearls and a frozen instant tapioca pearl made therefrom.

2. Description of the Related Art

Tapioca pearls are a very popular food material and are widely used in various desserts and beverages. The tapioca peals are usually obtained by mixing tapioca flour and water to make a dough, followed by kneading and processing the dough into pearl-shaped raw tapioca pearls. The raw tapioca pearls are cooked for 20 minutes to 30 minutes using hot water in a pot, and then, the pot is covered with a cover to immerse the tapioca pearls in hot water for 20 minutes to 30 minutes so as to fully cook the tapioca pearls. Thereafter, the cooked tapioca pearls are washed with water, followed by draining out water and soaking the cooked tapioca pearls with sugar. The preparation process of the tapioca pearls is complicated and time consuming, and preservation of the tapioca pearls is also difficult since the cooked tapioca pearls would become hard after storing in a refrigerator and would become too soft after undergoing recooking. Therefore, most consumers buy the tapioca pearls desserts or beverages instead of preparing the same.

### SUMMARY OF THE INVENTION

The object of the present invention is to provide a method for manufacturing frozen instant tapioca pearls, that is adapted for mass production and efficient manufacture of the frozen instant tapioca pearls.

According to one aspect of this invention, there is provided a method for manufacturing frozen instant tapioca pearls, including: (a) preparing raw tapioca pearls; (b) cooking the raw tapioca pearls to obtain cooked tapioca pearls; (c) soaking the cooked tapioca pearls in a hot water solution; (d) after step (c), cooling the cooked tapioca pearls using ice water; and (e) after step (d), blowing cold air with a temperature of −5° C. to −40° C. over the cooked tapioca pearls at a wind speed ranging from 3 m/sec to 5 m/sec and a wind pressure ranging from 500 Pa to 1000 Pa so as to separate and quickly freeze the cooked tapioca pearls.

According to another aspect of this invention, there is provided a frozen instant tapioca pearl made by the aforesaid method.

### BRIEF DESCRIPTION OF THE DRAWINGS

Other features and advantages of the present invention will become apparent in the following detailed description of the preferred embodiment with reference to the accompanying drawings, of which:

FIG. 1 is a flow chart to illustrate the preferred embodiment of a method for manufacturing frozen instant tapioca pearls;

FIG. 2 is a flow chart to illustrate a step for preparing raw tapioca pearls in the preferred embodiment;

FIG. 3 is a schematic diagram showing steps of freezing cooked tapioca pearls by a quick freezing device and vibrating the frozen instant tapioca pearls in the preferred embodiment;

FIG. 4 is a top view to illustrate the steps shown in FIG. 3;

FIG. 5 is a schematic diagram to illustrate using the frozen instant tapioca pearls made by the preferred embodiment to make a tapioca pearl-containing beverage;

FIG. 6 is a flow chart to illustrate a modified step for preparing the raw tapioca pearls of the preferred embodiment using a mold;

FIG. 7 illustrates consecutive steps for preparing the raw tapioca pearls of the preferred embodiment using the mold; and

FIG. 8 is a schematic diagram showing the raw tapioca pearls with various shapes.

### DETAILED DESCRIPTION OF THE PREFERRED EMBODIMENT

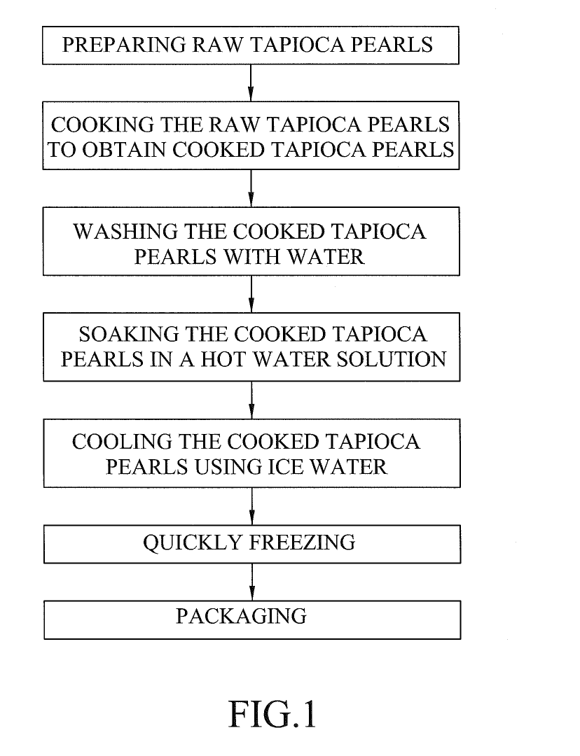

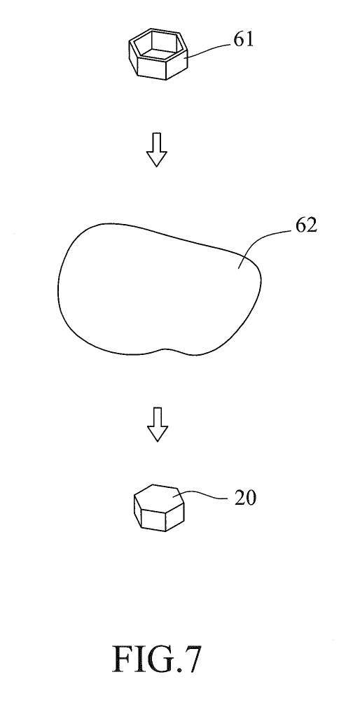

Referring to FIGS. 1 and 7, the preferred embodiment of a method for manufacturing frozen instant tapioca pearls according to this invention includes the steps of: (a) preparing raw tapioca pearls 20 (see FIG. 7); (b) cooking the raw tapioca pearls 20 to obtain cooked tapioca pearls; (c) soaking the cooked tapioca pearls in a hot water solution; (d) after step (c), cooling the cooked tapioca pearls using ice water to obtain cooled cooked tapioca pearls 21; and (e) after step (d), blowing cold air with a temperature of −5° C. to −40° C. over the cooled cooked tapioca pearls 21 at a wind speed ranging from 3 m/sec to 5 m/sec and a wind pressure ranging from 500 Pa to 1000 Pa so as to separate and quickly freeze the cooked tapioca pearls.

When the wind pressure is less than 500 Pa, each of the cooked tapioca pearls is frozen incompletely. When the windpressure is greater than 1000 Pa, the cooked tapioca pearls may collide with each other so that the cooked tapioca pearls may be damaged, and the high wind pressure would require relatively high electric power, thereby resulting in an increase in manufacturing costs.

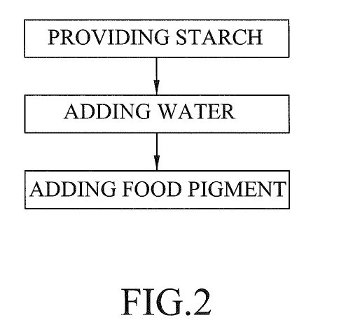

As shown in FIGS. 2 and 7, in step (a) , preparation of the raw tapioca pearls 20 is conducted by adding starch with water and a food pigment to form a dough 62, followed by shaping the dough 62 to form the raw tapioca pearls 20 with desired shapes, such as a pearl shape . The preferred ratio of the starch to water is 2 to 1. Examples of the starch include tapioca flour, sweet potato flour, potato flour, and combinations thereof. Examples of the food pigment include caramel pigment, monascus pigment, gardenia pigment, and combinations thereof. To be specific, each of the abovementioned food pigments exhibits a different color, and could be mixed to present various colors. For example, the raw tapioca pearls 20 present caramel color by adding only the caramel pigment, present red color by adding only the monascus pigment, present yellow color by adding only the gardenia pigment, present green color by adding the monascus pigment and the gardenia pigment simultaneously, and present rufous color by adding the caramel pigment and the monascus pigment simultaneously.

In step (b), the raw tapioca pearls 20 are cooked for 5 minutes to 20 minutes in boiling water to obtain cooked tapioca pearls. In step (c, the cooked tapioca pearls are washed with water and are then soaked in a hot water solution for 30 minutes to 45 minutes. The hot water solution preferably has a temperature ranging from 85° C. to 95° C., and contains sugar of molasses or fructose so that the cooked tapioca pearls absorb the sugar to exhibit a sweet taste.

After step (c), in step (d), the cooked tapioca pearls are cooled by soaking them in ice water at 0° C. to 10 ° C. for 60 minutes to 180 minutes to decrease the viscosity of the cooked tapioca pearls and improve their chewy taste . The cooled cooked tapioca pearls 21 are still sticky and are likely to aggregate.

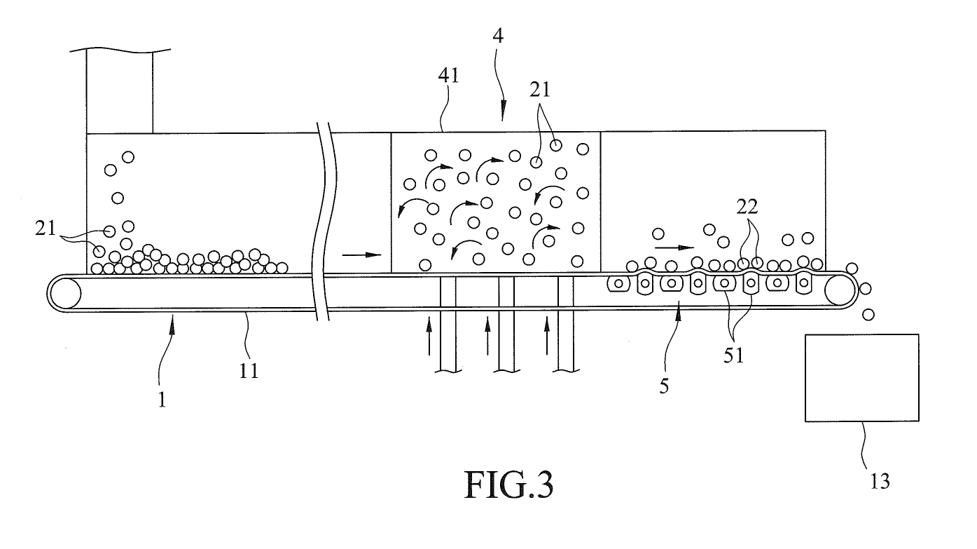

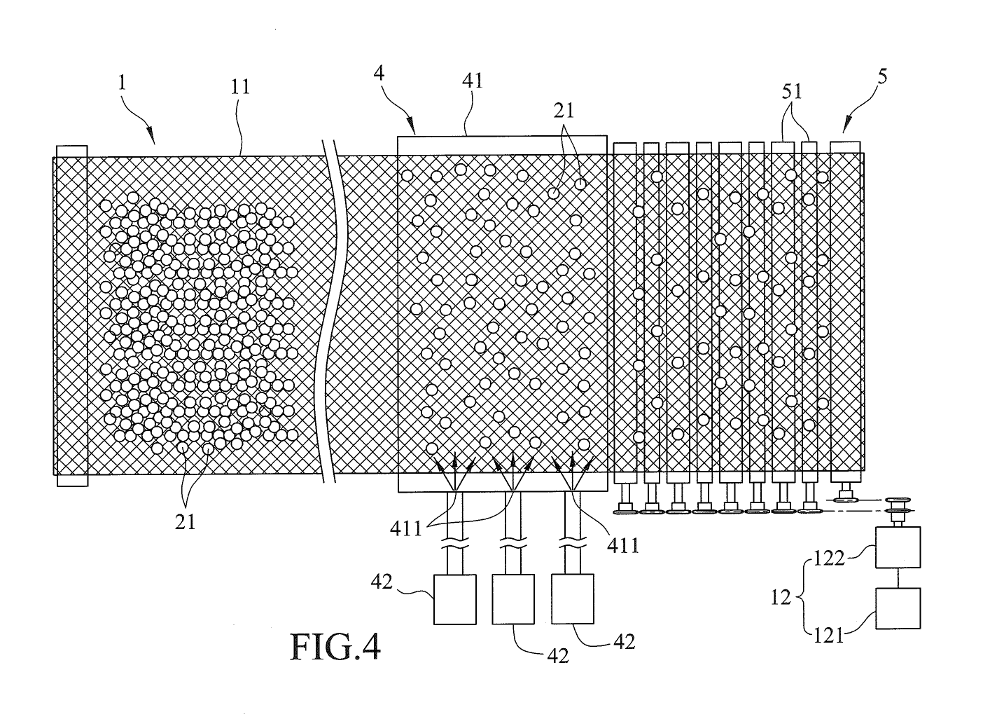

As shown in FIGS. 3 and 4, in step (e), the cooled cooked tapioca pearls 21 are transported to a quick freezing device 4 to freeze the cooked tapioca pearls 21, so that the frozen instant tapioca pearls 22 are obtained using a transporting unit 1 which includes a conveyor belt 11 and a driving device 12 for driving the conveyor belt 11. The conveyor belt 11 can be a reticular conveyor belt or a non-reticular conveyor belt. When the conveyor belt 11 has the reticular form, impurities are easily to be removed. The driving device 12 includes a power source 121 and a motor 122 electrically connecting to the power source 121 and driving the conveyor belt 11. The quick freezing device 4 includes a housing 41 and at least one quick air-blast freezer 42 connecting to the housing 41 for producing and providing the cold air to the housing 41. In the preferred embodiment, there are provided three quick air-blast freezers 42, but the number of the quick air-blast freezers 42 is not limited thereto. The cooled cooked tapioca pearls 21 are transported into the housing 41 of the quick freezing device 4 by the conveyor belt 11. The housing 41 of the quick freezing device 4 has three openings 411 spaced apart from each other, and each of the quick air-blast freezers 42 connects to a respective one of the openings 411, so that the cold air generated from the quick air-blast freezers 42 is directed into the housing 41 through the openings 411. Preferably, the cold air has a wind speed ranging from 75 m/sec to 80 m/sec at the openings 411.

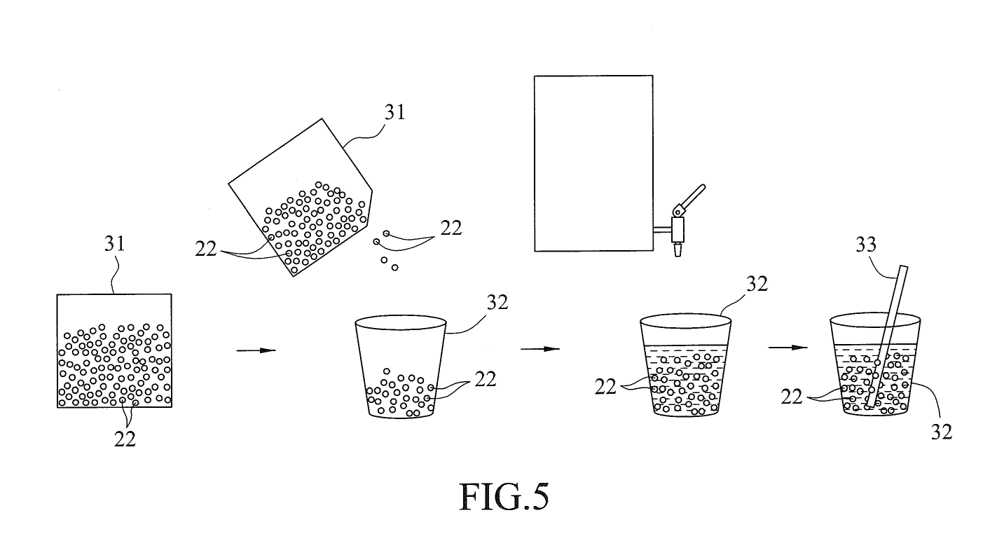

The method of the preferred embodiment may further include, after step (e), vibrating the frozen instant tapioca pearls 22 using a vibrating unit 5 so as to separate the frozen instant tapioca pearls 22 from each other, and packaging the frozen instant tapioca pearls 22, wherein the vibrating unit 5 is disposed downstream of the quick freezing device 4 and includes a plurality of cam wheels 51 rotatably disposed under the conveyor belt 11. Furthermore, as shown in FIG. 3, after passing through the vibrating unit 5, the frozen instant tapioca pearls 22 are fed into a container 13. The frozen instant tapioca pearls 22 are then packed using various sizes of packaging bags 31 for freeze storage (see FIG. 5). The size of the packaging bag 31 is dependent on actual requirements.

Referring to FIG. 5, in use, the frozen instant tapioca pearls 22 are poured out of the packaging bag 31 into a cup 32, and are added with desired drinks, followed by stirring using a stir bar 33. After the frozen instant tapioca pearls 22 are thawed, a beverage containing the instant tapioca pearls 22 is obtained. Examples of the desired drinks include, but are not limited to, water, juice, milk tea, black tea, green tea, milkshake, and fizzy drinks.

When the frozen instant tapioca pearls 22 are used in desserts such as shaved ice, the frozen instant tapioca pearls 22 are thawed in water, and the thawed instant tapioca pearls 22 could be added onto the shaved ice. The flavor and mouth feel of the thawed instant tapioca pearls 22 can be maintained at room temperature (26° C.) for 10 hours. Additionally, when the frozen instant tapioca pearls 22 are used in hot beverages, the mouth feel of the instant tapioca pearls 22 would be improved by soaking the same in the hot beverages for a while.

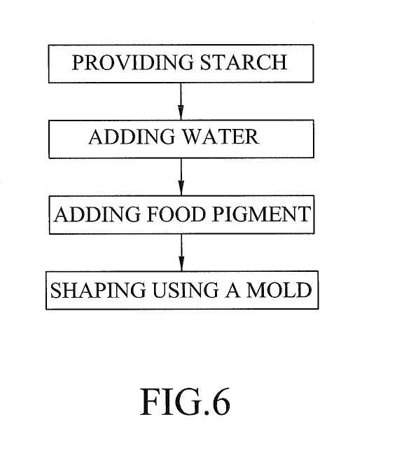

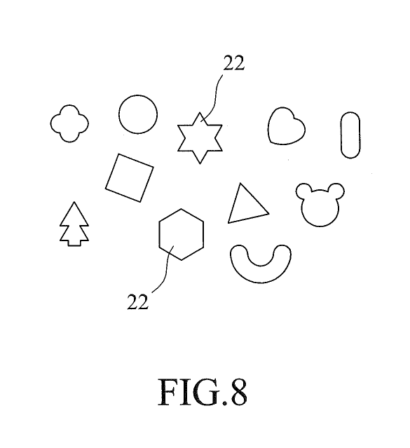

Referring to FIGS. 6 to 8, instep (a), the raw tapioca pearls 20 can be made using a mold 61, thereby obtaining the tapioca pearls with various shapes, e.g., star shape, triangular shape, heart shape, polygonal shape, meniscoid shape, and tree shape. To be specific, in step (a), the mold 61 can be pressed into the dough 62, removing the excess dough 62 outside of the mold 61, and removing the shaped dough 62 from the mold 61 so as to obtain the raw tapioca pearls 20. Alternatively, the dough 62 can be directly pressed into the mold 61 to obtain the raw tapioca pearls 20.

To sum up, the method for manufacturing the frozen instant tapioca pearls 22 according to this invention is simple and quick, and the frozen instant tapioca pearls 22 thus made are convenient to be consumed. In use, the frozen instant tapioca pearls 22 are poured into a cup 32 and water or beverages are added to the cup 32 with stirring, to thereby prepare the drink containing the tapioca pearls 22. The frozen instant tapioca pearls 22 are packed using the packaging bag 31 for long-term freeze storage.

While the present invention has been described in connection with what are considered the most practical and the preferred embodiments, it is understood that this invention is not limited to the disclosed embodiments but is intended to cover various arrangements included within the spirit and scope of the broadest interpretation and equivalent arrangements.

What is claimed is:

1. A method for manufacturing frozen instant tapioca pearls, comprising:
(a) preparing raw tapioca pearls;
(b) cooking the raw tapioca pearls to obtain cooked tapioca pearls;
(c) soaking the cooked tapioca pearls in a hot water solution;
(d) after step (c), cooling the cooked tapioca pearls using ice water; and
(e) after step (d) , blowing cold air with a temperature of −5° C. to −40° C. over the cooked tapioca pearls at a wind speed ranging from 3 m/sec to 5 m/sec and a wind pressure ranging from 500 Pa to 1000 Pa so as to separate and quickly freeze the cooked tapioca pearls.

2. The method for manufacturing frozen instant tapioca pearls as claimed in claim 1, wherein, in step (b), the raw tapioca pearls are cooked for 5 minutes to 20 minutes in boiling water; in step (c), the cooked tapioca pearls are washed with water and are then soaked in the hot water solution for 30 minutes to 45 minutes; and in step (d), the cooked tapioca pearls are cooled using ice water for 60 minutes to 180 minutes.

3. The method for manufacturing frozen instant tapioca pearls as claimed in claim 1, wherein, in step (c), the hot water solution has a temperature ranging from 85° C. to 95° C.

4. The method for manufacturing frozen instant tapioca pearls as claimed in claim 3, wherein the hot water solution contains sugar of molasses or fructose so that the cooked tapioca pearls absorb the sugar.

5. The method for manufacturing frozen instant tapioca pearls as claimed in claim 4, wherein step (d) is conducted by soaking the cooked tapioca pearls in ice water at 0° C. to 10° C.

6. The method for manufacturing frozen instant tapioca pearls as claimed in claim 5, wherein step (e) in conducted in a quick freezing device that includes a housing and a quick air-blast freezer for producing and providing the cold air to the housing, after step (d) , the cooled tapioca pearls being transported into the housing of the quick freezing device by a conveyor belt.

7. The method for manufacturing frozen instant tapioca pearls as claimed in claim 6, wherein the housing of the quick freezing device has an opening, the cold air generated from the quick air-blast freezer being directed into the housing through the opening.

8. The method for manufacturing frozen instant tapioca pearls as claimed in claim 7, wherein the cold air has a wind speed ranging from 75 m/sec to 80 m/sec at the opening.

9. The method for manufacturing frozen instant tapioca pearls as claimed in claim 6, further comprising, after step (e), vibrating the frozen instant tapioca pearls using a vibrating unit so as to separate the frozen instant tapioca pearls from each other, and packaging the frozen instant tapioca pearls.

10. The method for manufacturing frozen instant tapioca pearls as claimed in claim 9, wherein the vibrating unit is disposed downstream of the quick freezing device and includes a plurality of cam wheels rotatably disposed under the conveyor belt.

11. The method for manufacturing frozen instant tapioca pearls as claimed in claim 1, wherein preparation of the raw tapioca pearls in step (a) is conducted by mixing starch, water, and a food pigment to form a dough, followed by shaping the dough to form the raw tapioca pearls with desired shapes, the ratio of the starch to the water being 2 to 1, the starch being selected from the group consisting of tapioca flour, sweet potato flour, potato flour, and combinations thereof, the food pigment being selected from the group consisting of caramel pigment, monascus pigment, gardenia pigment, and combinations thereof.

12. The method for manufacturing frozen instant tapioca pearls as claimed in claim 11, wherein the desired shapes include a pearl shape.

13. A frozen instant tapioca pearl manufactured by the method of claim 1.
